(19) United States
(12) Patent Application Publication
(10) Pub. No.: US 2011/0317082 A1
(43) Pub. Date: Dec. 29, 2011

(54) LIQUID CRYSTAL SHUTTER AND LIQUID CRYSTAL SHUTTER GLASSES

(75) Inventors: Goroh Saitoh, Tokyo (JP); Junichirou Ishii, Tokyo (JP); Masao Imai, Tokyo (JP)

(73) Assignee: NEC CORPORATION, Tokyo (JP)

(21) Appl. No.: 13/201,005

(22) PCT Filed: Feb. 24, 2010
(86) PCT No.: PCT/JP2010/052828

§ 371 Date: Aug. 11, 2011

(30) Foreign Application Priority Data
Feb. 26, 2009 (JP) 2009-044045

(51) Int. Cl. G02F 1/1335

(52) U.S. Cl. 349/13; 349/96

(57) ABSTRACT

Disclosed is a liquid crystal shutter having two superimposed liquid crystal layers in which no leakage of light occurs. In a liquid crystal shutter in which oriented films (11) of a pair of substrates of each liquid crystal device (8a, 8b) are oriented in mutually intersecting directions, and are all vertically oriented films or horizontally oriented films, and if the oriented films are horizontally oriented films, the liquid crystal materials have a positive dielectric constant isotropy, and if the oriented films are vertically oriented films, the liquid crystal materials have a negative dielectric constant isotropy, the twist directions (13) of the liquid crystal materials en- closed in the adjacent liquid crystal devices (8a, 8b) are opposite to each other to thereby prevent the leakage of light.

### TECHNICAL FIELD

The present invention relates to a liquid crystal shutter and liquid crystal shutter glasses incorporating liquid crystal shutters, and more particularly to a liquid crystal shutter for use in a stereoscopic display system or a multi-view display system which utilizes a time-division display, and liquid crystal shutter glasses incorporating liquid crystal shutters.

### BACKGROUND ART

There has been proposed or developed a time-division display system incorporating liquid crystal shutter glasses and a time-division display which displays a plurality of images on time-division principles. A one time-division display system is a stereoscopic display system for making the observer perceive stereoscopic images, for example.

FIG. 1 is a schematic view of a stereoscopic display system. As shown in FIG. 1, the stereoscopic display system includes liquid crystal shutter glasses 1 and liquid crystal display apparatus 30 as a time-division display. Liquid crystal shutter glasses 1 include right-eye liquid crystal shutter 1a and left-eye liquid crystal shutter 1b.

Liquid crystal display apparatus 30 alternately displays a right-eye image and a left-eye image. Right-eye liquid crystal shutter 1a and left-eye liquid crystal shutter 1b switch between a transmitted state and a blocked state in synchronism with the display of the right-eye image and the left-eye image, guiding the right-eye image to the right eye of observer 2 and guiding the left-eye image to the left eye of observer 2. If the right-eye image and the left-eye image are images depending on the disparity of the right and left eyes, then it is possible for the observer to perceive a stereoscopic image.

Another time-division display system is a multi-view display system which allows a plurality of observers to perceive respective different images. One such multi-view display system is disclosed in Patent document 1.

FIG. 2 is a schematic view of a multi-view display system. As shown in FIG. 2, the multi-view display system includes liquid crystal shutter glasses 1 and liquid crystal display apparatus 30, as with the stereoscopic display system shown in FIG. 1. It is assumed that there are three observers (observers 2a through 2c).

In the multi-view display system, liquid crystal display apparatus 30 sequentially displays images for the respective observers. The liquid crystal shutter glasses, which are used respectively by observers 2a through 2c, switch between a transmitted state and a blocked state in synchronism with the display of the images displayed for the respective observers, guiding the displayed images to the respective observers. Therefore, observers 2a through 2c can perceive the different displayed images, respectively.

Still another time-division display system is a secure display system which allows only the user of liquid crystal shutter glasses 1 to perceive a displayed image. The secure display system employs the display of a portable information terminal such as a laptop personal computer as a time-division display, thereby making the portable information terminal capable of dealing with highly confidential information.

FIG. 3 is a schematic view of a secure display system.

As shown in FIG. 3, portable information terminal 3 includes time-division display 4 that alternately displays an image and a reverse image thereof such as image A and reverse image A′ of displayed image A or image B and reverse image B′ of displayed image B. An observer who is not wearing liquid crystal shutter glasses 1 cannot perceive displayed images A, B because they perceive displayed and reverse images that are integrated into achromatic images.

When liquid crystal shutter glasses 1 are brought into a transmitted state in synchronism with the display of displayed images A, B and when they are brought into a blocked state in synchronism with the display of inverted images A′, B′, it is possible for observer 2 who is wearing liquid crystal shutter glasses 1 to perceive displayed images A, B.

The liquid crystal shutter glasses in the above time-division display systems are required to have high contrast characteristics which provide a large difference between the amounts of light that are transmitted in the transmitted state and the blocked state and also a high-speed response for quickly switching between the transmitted state and the blocked state. Without these characteristics, the system will suffer a phenomenon (crosstalk) wherein a displayed image which is to be shielded is transmitted and perceived by an observer and a phenomenon wherein a displayed image looks dark, resulting in a failure to make an observer perceive a good displayed image.

When a voltage is applied to the liquid crystal used in a liquid crystal shutter, the liquid crystal is brought into an oriented state (ON state), and when no voltage is applied to the liquid crystal, the liquid crystal is brought into another oriented state (OFF state). The change between these oriented states causes a change in the transmittance of light through the liquid crystal. The liquid crystal shutter switches between a transmitted state and a blocked state when the liquid crystal switches between the ON state and the OFF state.

The time that the liquid crystal takes to change from the ON state to the OFF state (OFF response time) when the voltage applied to the liquid crystal in the ON state ceases to be applied is longer than the time that the liquid crystal takes to change from the OFF state to the ON state (ON response time) when the voltage is applied to the liquid crystal in the OFF state. Therefore, the time required for the liquid crystal shutter to change from the transmitted state to the blocked state is different from the time required for the liquid crystal shutter to change from the blocked state to the transmitted state. The time difference tends to cause crosstalk, and the result is that this causes the observer to fail to perceive a good displayed image.

Technologies capable of solving the above problems include a liquid crystal display apparatus disclosed in Patent document 2 and a light control device disclosed in Patent document 3.

The liquid crystal display apparatus disclosed in Patent document 2 includes two liquid crystal cells having nematic liquid crystals oriented horizontally and stacked one on the other such that the oriented directions of the liquid crystal cells extend perpendicularly to each other, and polarization layers disposed on respective both sides of the stacked liquid crystal cells.

When no voltage is applied to the liquid crystal cells, the liquid crystal display apparatus is in a blocked state. When a voltage is applied to only one of the liquid crystal cells, the liquid crystal display apparatus is in a transmitted state. When voltages are applied to both the liquid crystal cells, the liquid crystal display apparatus is back in the blocked state.

It is assumed that the liquid crystal display apparatus is in a blocked state, which serves as an initial state, when no voltage is applied to the liquid crystal cells. When a voltage is applied to one of the liquid crystal cells, the liquid crystal display apparatus changes from the blocked state to a transmitted state. Thereafter, when a voltage is applied to the other liquid crystal cell, the liquid crystal display apparatus changes from the transmitted state to the blocked state. When the voltages cease to be applied to both the liquid crystal cells, the liquid crystal display apparatus is back in the initial state.

In this manner, the time required to bring the liquid crystal display apparatus from the blocked state into the transmitted state and the time required to bring the liquid crystal display apparatus from the transmitted state into the blocked state are substantially the same as the ON response time. Therefore, it is possible to equalize the time required to bring the liquid crystal display apparatus from the transmitted state into the blocked state and the time required to bring the liquid crystal display apparatus from the blocked state into the transmitted state.

The light control device disclosed in Patent document 3 includes two TN liquid crystal cells stacked one on the other such that the oriented directions of the TN liquid crystal cells extend perpendicularly to each other when no voltage is applied to the TN liquid crystal cells, and polarization layers disposed on respective both sides of the stacked TN liquid crystal cells. The light control device is energized in the same manner as with the liquid crystal display apparatus disclosed in Patent document 2 to make it possible to equalize the time required to bring the light control device from the transmitted state into the blocked state and the time required to bring the light control device from the blocked state into the transmitted state.

Aside from the above technologies, Patent document 4 discloses a liquid crystal display apparatus as a technology for realizing high contrast characteristics.

The disclosed liquid crystal display apparatus includes two TN liquid crystal cells stacked one on the other such that the angular spacing between the orientation axes of the TN liquid crystal cells on the visually perceived sides thereof is kept within 10°, and polarization layers disposed on upper and lower ends of the stacked liquid crystal cells and between the stacked liquid crystal cells. The structure with the two stacked TN liquid crystal cells makes it possible to realize higher contrast characteristics than a single TN liquid crystal cell.

### PRIOR TECHNICAL DOCUMENTS

### Patent document

Patent document 1: JP2006-186763A

Patent document 2: JP5-297402A

Patent document 3: JP50-141344A

Patent document 4: JP2004-258372A

### SUMMARY OF THE INVENTION:

With the liquid crystal display apparatus disclosed in Patent document 2, the liquid crystal cells whose nematic liquid crystal is horizontally oriented are stacked one on the other. The nematic liquid crystal that is horizontally oriented generally needs a high drive voltage and is difficult to use in liquid crystal shutter glasses that are often driven by batteries. Furthermore, since the horizontally oriented nematic liquid crystal has a slow OFF response time, the liquid crystal display apparatus takes a long time until it is brought back into the initial state by stopping the voltage applied to both the liquid crystal cells, and hence fails to have a high response. Consequently, it is difficult to apply the technology disclosed in Patent document 2 to liquid crystal shutter glasses.

The light control device disclosed in Patent document 3 can solve the above the problems because it employs TN liquid crystal cells which have a short OFF response time and which can be driven under a low voltage, rather than using nematic liquid crystals.

However, as shown in FIG. 8 and page 13 of Patent document 3, there is a problem of light leakage that occurs when both the two TN liquid crystal cells are switched into the OFF state.

Patent documents 2 and 3 disclose nothing about the viewing angle characteristics of a liquid crystal shutter. Since the observer's eyes are likely to move sideways, liquid crystal shutter glasses are required to reduce light leakage in sideways directions with respect to the observer (particularly in directions to the center of the face toward which the eyes tend to move when viewing displays) in the blocked state.

Moreover, when both the liquid crystal cells change from the ON state to the OFF state (when they are turned off), the liquid crystal shutter needs to be kept in the blocked state. Therefore, even when the liquid crystal cells are turned off, it is necessary to reduce light leakage in sideways directions with respect to the observer.

The liquid crystal display apparatus disclosed in Patent document 4 has improved contrast when the liquid crystal is in a static drive mode. However, there is nothing disclosed in Patent document 4 about light leakage in the blocked state and the OFF time. The drive method for the liquid crystal display apparatus disclosed in Patent document 4 is widely different from the drive methods according to the technologies disclosed in Patent documents 2 and 3.

It is an object of the present invention to provide a liquid crystal shutter and liquid crystal shutter glasses which are highly responsive that will solve the problem of light leakage.

### MEANS FOR SOLVE THE PROBLEMS

According to the present invention, there is provided a liquid crystal shutter comprising a stacked structural body of a stack of liquid crystal devices each including a pair of substrates coated with respective orientation films and a liquid crystal material sealed between the substrates, a polarizer disposed on one of two opposite sides of said stacked structural body, and an analyzer disposed on the other of the two opposite sides of said stacked structural body, wherein the orientation films as a pair in said liquid crystal devices are oriented in directions which cross each other, said orientation films comprise either horizontal orientation films or vertical orientation films, said liquid crystal material having a positive dielectric anisotropy if said orientation films comprise said horizontal orientation films, and said liquid crystal material having a negative dielectric anisotropy if said orientation films comprise said vertical orientation films, and the liquid crystal materials of the liquid crystal devices which are disposed adjacent to each other in said stacked structural body are twisted in mutually opposite directions.

According to the present invention, there are also provided liquid crystal shutter glasses incorporating the above liquid crystal shutter.

### ADVANTAGES OF THE INVENTION

According to the present invention, it is possible to reduce light leakage.

### BRIEF DESCRIPTION OF THE DRAWINGS

FIG. 1 is a schematic view of a stereoscopic display system;

FIG. 2 is a schematic view of a multi-view display system;

FIG. 3 is a schematic view of a secure display system;

FIG. 4 is a vertical cross-sectional view schematically showing a structure of a liquid crystal shutter according to an exemplary embodiment of the present invention;

FIG. 5A is a vertical cross-sectional view schematically showing an example of liquid crystal device;

FIG. 5B is a vertical cross-sectional view schematically showing another example of liquid crystal device;

FIG. 5C is a vertical cross-sectional view schematically showing a more detailed structure of the liquid crystal shutter;

FIG. 6A is a perspective view schematically showing an example of liquid crystal glasses;

FIG. 6B is a schematic view showing a structural example of a liquid crystal shutter used in the liquid crystal glasses;

FIG. 7 is a schematic view showing an oriented direction and a pretilt angle direction of the liquid crystal shutter used in the liquid crystal glasses;

FIG. 8 is a diagram illustrative of operation of a liquid crystal shutter which uses a TN liquid crystal device as the liquid crystal device;

FIG. 9 is a diagram showing movement of a liquid crystal molecule upon a change from a voltage-applied state to a no-voltage-applied state;

FIG. 10 is a diagram illustrative of the operation of a liquid crystal shutter which uses an R-TN liquid crystal device as the liquid crystal device;

FIG. 11 is a schematic view of liquid crystal shutter glasses which employ a TN liquid crystal mode;

FIG. 12A is a diagram showing an example of luminance distribution of the liquid crystal shutter glasses at the time a voltage is applied to bring them into a blocked state;

FIG. 12B is a diagram showing another example of luminance distribution of the liquid crystal shutter glasses at the time the voltage is turned off;

FIG. 12C is a diagram showing still another example of luminance distribution of the liquid crystal shutter glasses at the time the voltage is turned off;

FIG. 12D is a diagram showing yet another example of luminance distribution of the liquid crystal shutter glasses at the time the voltage is turned off;

FIG. 13 is a diagram illustrative of light leakage in a frontal direction of a liquid crystal shutter;

FIG. 14 is a schematic view of liquid crystal shutter glasses which employ an R-TN liquid crystal mode;

FIG. 15A is a diagram showing an example of luminance distribution of the liquid crystal shutter glasses at the time a voltage is applied to bring them into a blocked state;

FIG. 15B is a diagram showing another example of luminance distribution of the liquid crystal shutter glasses at the time the voltage is turned off;

FIG. 15C is a diagram showing still another example of luminance distribution of the liquid crystal shutter glasses at the time the voltage is turned off; and

FIG. 15D is a diagram showing yet another example of luminance distribution of the liquid crystal shutter glasses at the time the voltage is turned off.

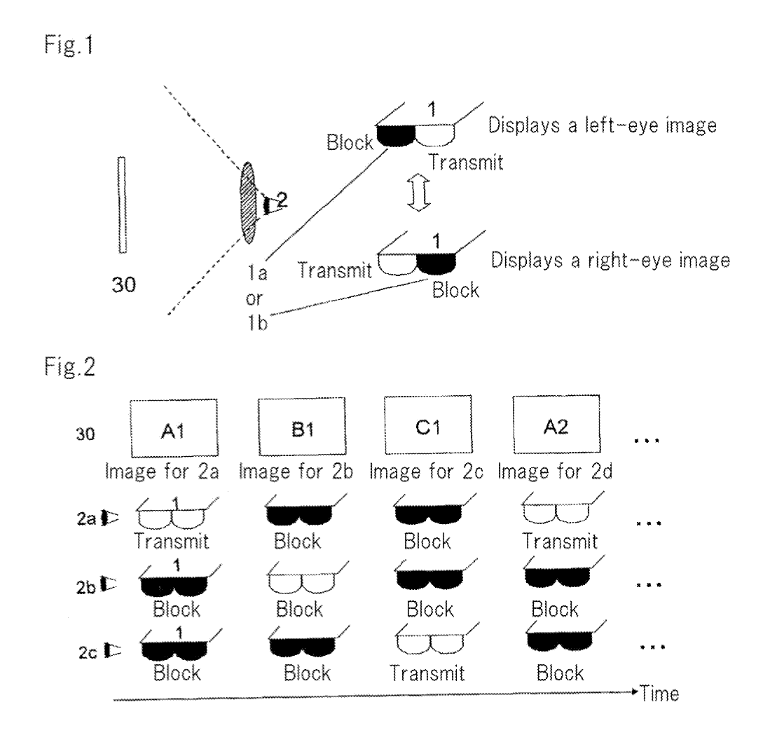

### MODE FOR CARRYING OUT THE INVENTION

Exemplary embodiments of the present invention will be described below with reference to the drawings. In the description that follows, components having identical functions may be denoted by identical reference characters and may not be described in detail.

FIG. 4 is a vertical cross-sectional view schematically showing a structure of a liquid crystal shutter according to an exemplary embodiment of the present invention. As shown in FIG. 4, liquid crystal shutter 5 includes a stacked structural body having a stack of liquid crystal devices 8a, 8b, polarizer 9, and analyzer 10. In FIG. 4, the liquid crystal shutter includes two liquid crystal devices. However, the liquid crystal shutter may include a plurality of liquid crystal devices.

Polarizer 9 is disposed on one side of the stacked structural body, and analyzer 10 is disposed on the other side of the stacked structural body. Each of liquid crystal devices 8a, 8b includes a pair of substrates 6 each coated with orientation film and liquid crystal material 7 sealed between substrates 6. Each of substrates 6 has electrodes (not shown) for applying voltages to liquid crystal devices 8a, 8b. Both sides of the stacked structural body have surfaces lying parallel to substrates 6 of liquid crystal devices 8a, 8b in the stacked structural body.

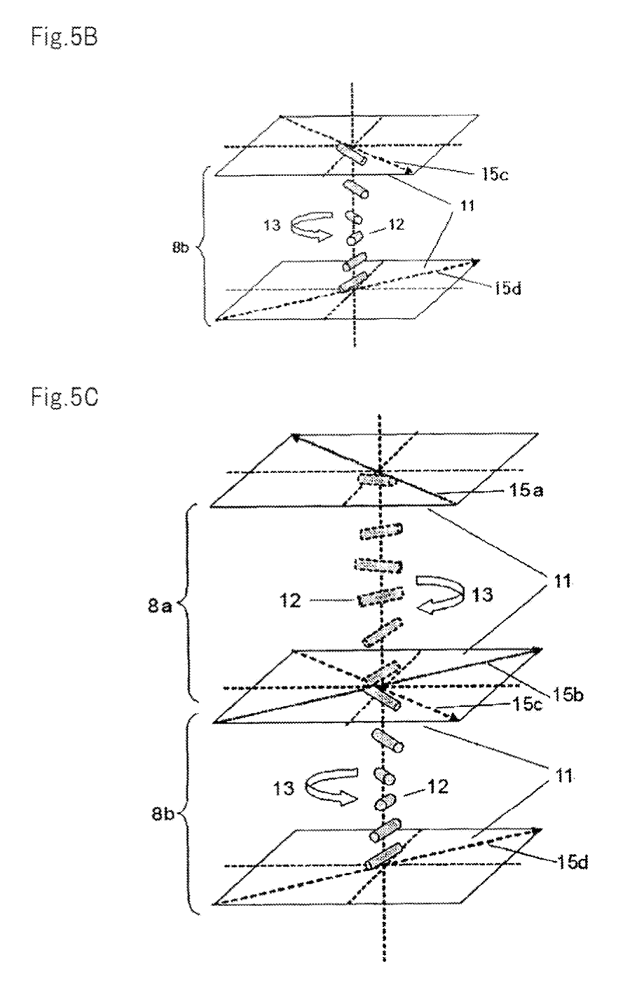

FIG. 5A s a vertical cross-sectional view schematically showing an example of liquid crystal device, FIG. 5B is a vertical cross-sectional view schematically showing another example of liquid crystal device, and FIG. 5C is a vertical cross-sectional view schematically showing a more detailed structure of the liquid crystal shutter.

In FIGS. 5A through 5C, horizontal orientation films 11 are provided as orientation films that are applied to respective substrates 6 of liquid crystal devices 8a, 8b. A liquid crystal material of positive dielectric anisotropy is sealed as liquid crystal material 7 between substrates 6 of liquid crystal devices 8a, 8b.

Liquid crystal devices 8a, 8b can be produced, for example, by applying horizontal orientation films 11 to substrates 6 which have transparent electrodes, orienting (e.g., rubbing) horizontal orientation films 11, and thereafter filling liquid crystal material 7 of positive dielectric anisotropy between substrates 6.

At this time, horizontal orientation films 11 on substrates 6 as a pair in each of the liquid crystal devices are oriented so as to cross each other at a prescribed angle. In FIGS. 5A through 5C, oriented directions 15a through 15d of the horizontal orientation films on substrates 6 are illustrated. Specifically, oriented directions 15a, 15b represent oriented directions of substrates 6 as a pair in liquid crystal device 8a, and oriented directions 15c, 15d represent oriented directions of substrates 6 as a pair in liquid crystal device 8b. Oriented directions 15a, 15b cross each other, and oriented directions 15c, 15d cross each other.

Liquid crystal materials 7 that are sealed respectively in liquid crystal devices 8a, 8b which are disposed adjacent to each other have liquid crystal molecules twisted in mutually opposite twisted directions 13.

Vertical orientation films may be provided instead of horizontal orientation films 11. If vertical orientation films are employed, then a liquid crystal material of negative dielectric anisotropy is sealed as liquid crystal material 7 between substrates 6 of liquid crystal devices 8a, 8b. As with horizontal orientation films 11, liquid crystal materials 7 that are sealed respectively in liquid crystal devices 8a, 8b which are disposed adjacent to each other have liquid crystal molecules twisted in mutually opposite twisted directions. The twisted directions with respect to the vertical orientation films represent twisted directions at the time the liquid crystal molecules of liquid crystal material 7 have fallen. All orientation films of liquid crystal devices 8a, 8b comprise orientation films of one type, i.e., either horizontal orientation films or vertical orientation films.

According to liquid crystal shutter 5, when a voltage is applied to or a voltage ceases to be applied to liquid crystal molecules 12 of stacked liquid crystal devices 8a, 8b, liquid crystal molecules 12 move symmetrically about directions normal to substrates 6. Therefore, it is possible to reduce light leakage when liquid crystal shutter 5 is in a blocked state.

As shown in FIG. 5C, the orientation films on the substrates, which are adjacent to each other, of stacked liquid crystal devices 8a, 8b should desirably be oriented in mutually perpendicular directions. Specifically, it is desirable that the prescribed angle refer to 90°, and oriented directions 15b, 15c of the orientation films on the substrates that are adjacent to each other extend perpendicularly to each other. With this arrangement, it is possible to increase the contrast between the transmitted state and the blocked state of liquid crystal shutter 5.

It is also desirable that the products (d·Δn) of thicknesses d of liquid crystal materials 7 of liquid crystal devices 8a, 8b and refractive index anisotropies Δn of liquid crystal materials 7 be equal or substantially equal to each other. It is further desirable that the chiral pitches of liquid crystal materials 7 of liquid crystal devices 8a, 8b be equal or substantially equal to each other. In these cases, it is possible to further reduce light leakage in the blocked state.

Polarizer 9 and analyzer 10 should desirably be disposed in crossed nicols relationship.

Liquid crystal shutter glasses incorporating liquid crystal shutters 5 will be described below.

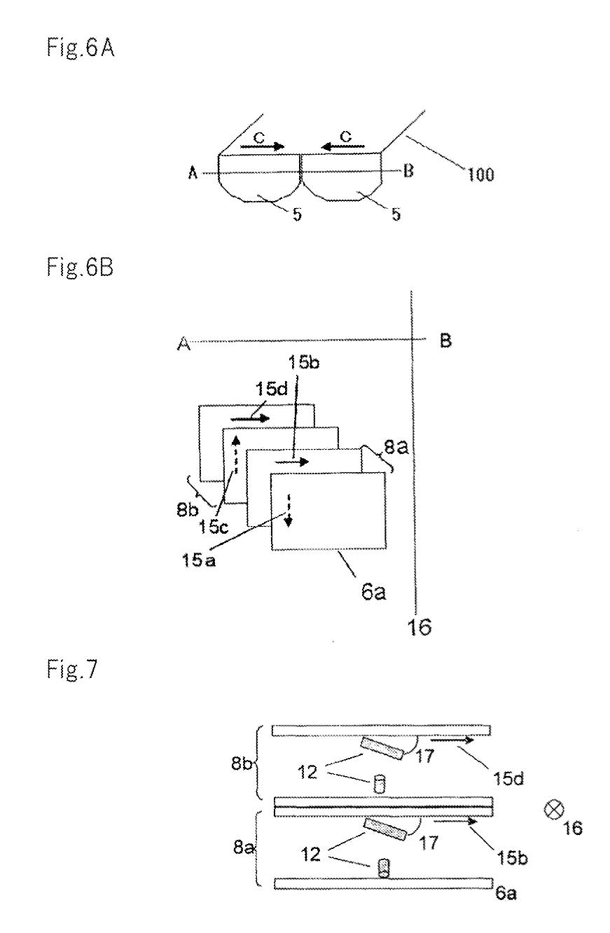

FIG. 6A is a perspective view schematically showing liquid crystal shutter glasses incorporating liquid crystal shutters 5. As shown in FIG. 6A, liquid crystal shutter glasses 100 include left and right glass frames each having liquid crystal shutter 5 mounted therein.

FIG. 6B is a schematic view showing a structure of liquid crystal shutter 5 used in liquid crystal glasses 100. It is assumed that liquid crystal shutter 5 includes two liquid crystal devices 8a, 8b.

In each of liquid crystal devices 8a, 8b, the orientation film on one of the substrates is oriented in a widthwise direction (A-B direction) of liquid crystal glasses 100. In the present exemplary embodiment, oriented direction 15b of the orientation film on the rear substrate of liquid crystal device 8a and oriented direction 15d of the orientation film on the rear substrate of liquid crystal device 8b are pointed in a widthwise direction of liquid crystal glasses 100.

Oriented directions 15b, 15d thus extend perpendicularly to central line 16 of the face of the observer. In FIG. 6B, front substrate 6a of liquid crystal device 8a faces the observer. In this manner, the viewing angle characteristics in lateral directions with respect to observer 2 are improved.

If the orientation films of liquid crystal devices 8a, 8b are horizontal orientation films 11, then as shown in FIG. 7, the longer axes of liquid crystal molecules on substrates 6 (on the interfaces of substrates 6) which have orientation films that are oriented in a widthwise direction are progressively spaced away from substrates 6 toward the inner side of liquid crystal shutter glasses 100 (in the directions indicated by arrows C in FIG. 6A). Accordingly, pretilt angles 17 of the substrates are directed toward the center of the face of the observer, thereby improving the viewing angle characteristics in lateral directions with respect to observer 2.

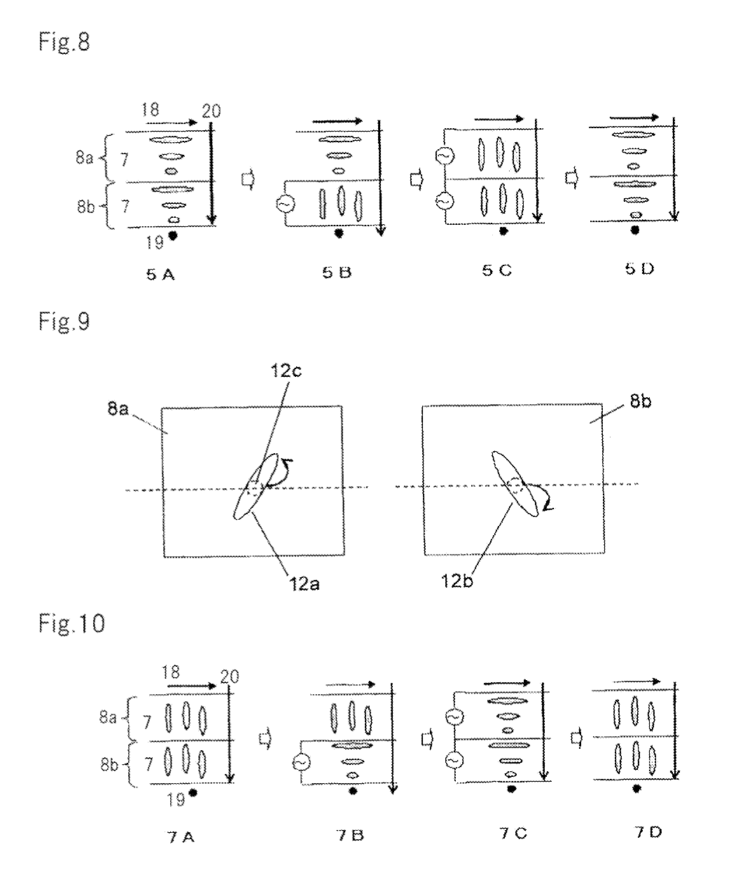

Operation of liquid crystal shutter 5 will be described below. FIGS. 8 through 10 are diagrams illustrative of the operation of liquid crystal shutter 5. It is assumed that polarizer 9 and analyzer 10 are disposed in a crossed nicols relationship such that transmission axis 18 of polarizer 9 and transmission axis 19 of analyzer 10 extend perpendicularly to each other.

FIG. 8 is a diagram illustrative of operation of liquid crystal shutter 5 in which liquid crystal devices 8a, 8b include horizontal orientation films 11.

If liquid crystal devices 8a, 8b include horizontal orientation films 11, as shown in FIG. 8, when no voltage is applied to both liquid crystal devices 8a, 8b (state 5A: both liquid crystal devices in the OFF state), respective liquid crystal materials 7 of liquid crystal devices 8a, 8b are twisted between substrates 6. It is assumed hereinbelow that the oriented directions of the orientation films of respective liquid crystal devices 8a, 8b are angularly spaced from each other by 90°. In other words, respective liquid crystal materials 7 of liquid crystal devices 8a, 8b are twisted by 90°. Such a liquid crystal device is referred to as a 90° TN liquid crystal device.

In state 5A, incident light 20 applied to liquid crystal shutter 5 passes through polarizer 9 as polarized light, and incident light 20 as polarized light is applied to liquid crystal devices 8a, 8b. The polarization plane of incident light 20 rotates along the direction in which the liquid crystal materials of liquid crystal devices 8a, 8b are twisted. At this time, since liquid crystal materials 7 sealed in liquid crystal devices 8a, 8b are twisted respectively in opposite directions, the polarization plane is rotated by 90° in liquid crystal devices 8a, 8b on the incident side and thereafter rotated back in liquid crystal devices 8a, 8b on the observer side. As polarizer 9 and analyzer 10 are disposed in a crossed nicols relationship, incident light 20 as polarized light cannot pass through analyzer 10, but is absorbed by analyzer 10. Therefore, liquid crystal shutter 5 is in the blocked state.

When a voltage equal to or higher than the saturation voltage is applied to liquid crystal device 8b in state 5A, the longer axes of the liquid crystal molecules in liquid crystal device 8b are oriented perpendicularly to substrate 6, removing the twist of liquid crystal material 7 of liquid crystal device 8b (state 5B: one liquid crystal device in the OFF state). At this time, the polarization plane of incident light 20 is not rotated in liquid crystal device 8b. Consequently, incident light 20 with its polarization plane rotated by 90° is applied to analyzer 10, and passes through analyzer 10. Therefore, liquid crystal shutter 5 is in the transmitted state. The saturation voltage refers to the saturation voltage of liquid crystal material 7.

When a voltage equal to or higher than the saturation voltage is also applied to liquid crystal device 8a in state 5B, the longer axes of the liquid crystal molecules in liquid crystal device 8a are oriented perpendicularly to substrate 6, removing the twist of liquid crystal material 7 of liquid crystal device 8a (state 5C: both liquid crystal devices in the ON state). At this time, the polarization plane of incident light 20 is not rotated in liquid crystal devices 8a, 8b. Consequently, incident light 20 cannot pass through analyzer 10. Therefore, liquid crystal shutter 5 is in the blocked state.

When voltages are thus applied to liquid crystal shutter 5, liquid crystal shutter 5 is brought from the blocked state into the transmitted state and from the transmitted state into the blocked state. Therefore, it is possible to change the states of liquid crystal shutter 5 at a high speed. Though voltages are applied to liquid crystal devices 8b, 8a successively in the named order in the above description, voltages may be applied to liquid crystal devices 8a, 8b successively in the named order.

When the voltages cease to be applied to liquid crystal devices 8a, 8b in state 5C, respective liquid crystal materials 7 of liquid crystal devices 8a, 8b are twisted (state 5D). At this time, liquid crystal shutter 5 remains in the blocked state.

When state 5C changes to state 5D, as shown in FIG. 9, since liquid crystal molecules 12c that are oriented perpendicularly to substrates 6 are twisted in opposite directions when no voltage is applied to liquid crystal devices 8a, 8b, liquid crystal molecules 12c become twisted symmetrically about lines normal to substrates 6. In other words, liquid crystal molecules 12a of liquid crystal device 8a and liquid crystal molecules 12b of liquid crystal device 8b become twisted in opposite directions. Therefore, while liquid crystal shutter 5 remains in the blocked state, it is possible for liquid crystal devices 8a, 8b to change to state 5A in which no voltage is applied to liquid crystal devices 8a, 8b, so that light leakage can be reduced.

FIG. 10 is a diagram illustrative of operation of liquid crystal shutter 5 in which liquid crystal devices 8a, 8b include vertical orientation films.

If liquid crystal devices 8a, 8b include vertical orientation films, as shown in FIG. 10, when no voltage is applied to both liquid crystal devices 8a, 8b (state 7A: both liquid crystal devices in the OFF state), respective liquid crystal materials 7 of liquid crystal devices 8a, 8b are oriented perpendicularly to substrates 6. When a voltage equal to or higher than the saturation voltage is applied to both liquid crystal devices 8a, 8b, since liquid crystal materials 7 have a negative dielectric anisotropy, liquid crystal materials 7 are oriented horizontally with respect to substrates 6 while being twisted about a direction normal to substrates 6. It is assumed hereinbelow that the oriented directions of the orientation films of respective liquid crystal devices 8a, 8b are angularly spaced from each other by 90°. In this case, when a voltage equal to or higher than the saturation voltage is applied to both of liquid crystal devices 8a, 8b, respective liquid crystal materials 7 of liquid crystal devices 8a, 8b are twisted by 90°. Such a liquid crystal device is referred to as an R-TN liquid crystal device.

In state 7A, incident light 20 applied to liquid crystal shutter 5 passes through polarizer 9 as polarized light, and incident light 20 as polarized light is applied to liquid crystal devices 8a, 8b. The polarization plane of incident light 20 does not rotate in liquid crystal devices 8a, 8b. Incident light 20 cannot pass through analyzer 10. Therefore, liquid crystal shutter 5 is in the blocked state.

When a voltage equal to or higher than the saturation voltage is applied to liquid crystal device 8b in state 7A, the longer axes of the liquid crystal molecules in liquid crystal device 8b are twisted horizontally with respect to substrate 6, and the polarization plane of incident light 20 is rotated by 90° in liquid crystal device 8b. Consequently, incident light 20 with its polarization plane rotated by 90° is applied to analyzer 10, and passes through analyzer 10. Therefore, liquid crystal shutter 5 is in the transmitted state (state 7B: one liquid crystal device in the OFF state).

When a voltage equal to or higher than the saturation voltage is also applied to liquid crystal device 8a in state 7B, liquid crystal material 7 of liquid crystal device 8a is twisted in a direction opposite to liquid crystal materials 7 of liquid crystal devices 8a, 8b, the polarization plane of incident light 20 is rotated by 90° in liquid crystal device 8a on the incident side, and thereafter rotated back in liquid crystal device 8b on the observer side. Consequently, incident light 20 cannot pass through analyzer 10. Therefore, liquid crystal shutter 5 is in the blocked state (state 7C: both liquid crystal devices in the ON state).

Even if the orientation films of liquid crystal devices 8a, 8b are vertical orientation films, as described above, when voltages are applied to liquid crystal shutter 5, liquid crystal shutter 5 is brought from the blocked state into the transmitted state and from the transmitted state into the blocked state. Therefore, it is possible to change the states of liquid crystal shutter 5 at a high speed. Though voltages are applied to liquid crystal devices 8b, 8a successively in the named order in the above description, voltages may be applied to liquid crystal devices 8a, 8b successively in the named order.

When the voltages cease to be applied to liquid crystal devices 8a, 8b in state 7C, respective liquid crystal materials 7 of liquid crystal devices 8a, 8b are oriented back perpendicularly to substrates 6 (state 7D). At this time, liquid crystal shutter 5 remains in the blocked state.

When state 7C changes to state 7D, since the twisted liquid crystal molecules are twisted in opposite directions, the liquid crystal molecules become twisted symmetrically about lines normal to substrates 6 and oriented back perpendicularly to substrates 6. Therefore, while liquid crystal shutter 5 remains in the blocked state, it is possible for liquid crystal devices 8a, 8b to change to state 5A in which no voltage is applied to liquid crystal devices 8a, 8b, so that light leakage can be reduced.

The above mechanism for reducing light leakage serves to reduce light leakage from light that is applied from the front face of liquid crystal shutter 5. Inasmuch as the liquid crystal devices have viewing angle characteristics, however, there is also required a mechanism for reducing light leakage in lateral directions with respect to the observer.

Light leakage in lateral directions with respect to observer 2 at the time liquid crystal shutter 5 is in the blocked state and at the time it is in the OFF state (at the time both liquid crystal devices in the ON state change to both liquid crystal devices in the OFF state) will be described below.

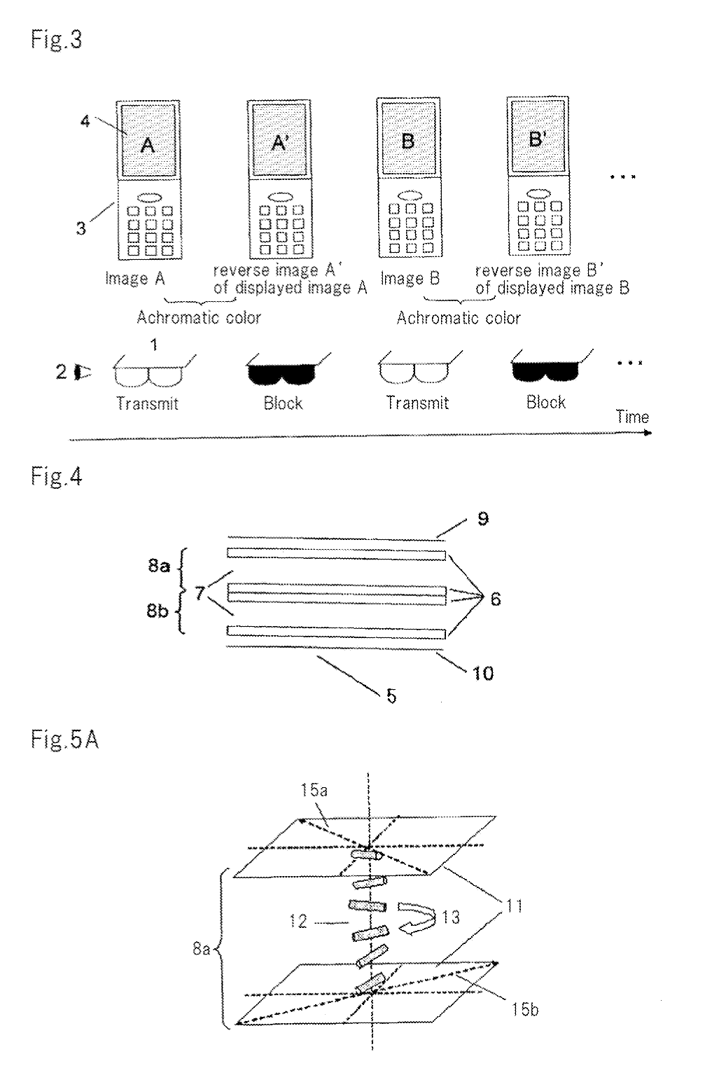

If a polarization layer is inserted between TN liquid crystal devices, so that the assembly is regarded as two stacked TN liquid crystal displays, as with the liquid crystal display apparatus disclosed in Patent document 4, then the viewing angle characteristics (light leakage in the blocked state and contrast between the blocked state and the transmitted state) of the liquid crystal display apparatus are considered to be a succession of the viewing angle characteristics of the individual TN liquid crystal displays. If liquid crystal devices are stacked one on the other and polarization layers (polarizer 9 and analyzer 10) are disposed on both sides of the stacked assembly, as with the liquid crystal shutter according to the present exemplary embodiment, then since the individual liquid crystal devices have different optical characteristics, the liquid crystal shutter does not have optical characteristics as disclosed in Patent document 4 (particularly, FIGS. 3, 4, and 10 of Patent document 4).

Light leakage in lateral directions with respect to the observer at the time liquid crystal shutter 5 is in the blocked state and the OFF state has been studied.

As a result of the study, it has become possible to reduce light leakage in lateral directions with respect to the observer provided that the oriented directions of the orientation films, which are oriented in the same direction, of liquid crystal devices 8a, 8b extend in a widthwise direction of liquid crystal shutter glasses 100, i.e., perpendicularly to the central line of the face of the observer. In particular, it has become possible to reduce light leakage in lateral directions with respect to Observer 2 that provided the longer axes of liquid crystal molecules on substrates 6 which have orientation films that are oriented in a widthwise direction are progressively spaced away from substrates 6 toward the inner side of liquid crystal shutter glasses 100.

Furthermore, if the orientation films are vertical orientation films, it has become possible to reduce more light leakage in lateral directions with respect to the observer at the time both of liquid crystal devices 8a, 8b are in the OFF state, than if the orientation films are horizontal orientation films, provided that the oriented directions of the orientation films, which are oriented in the same direction, of liquid crystal devices 8a, 8b extend in a widthwise direction of liquid crystal shutter glasses 100.

Advantages will be described below.

According to the present exemplary embodiment, the orientation films of a pair of substrates 6 of respective liquid crystal devices 8a, 8b are oriented in directions which cross each other. The orientation films are either horizontal orientation films 11 or vertical orientation films. If the orientation films are horizontal orientation films 11, then liquid crystal materials 7 have a positive dielectric anisotropy, and if the orientation films are vertical orientation films, then liquid crystal materials 7 have a negative dielectric anisotropy. The liquid crystal materials of liquid crystal devices 8a, 8b that are disposed adjacent to each other are twisted in mutually opposite directions.

When liquid crystal devices 8a, 8b are turned off, i.e., when both of them change from the ON state to the OFF state, liquid crystal molecules 12a of liquid crystal device 8a and liquid crystal molecules 12b of liquid crystal device 8b are twisted in opposite directions. Therefore, since both liquid crystal devices 8a, 8b can change to the OFF state while liquid crystal shutter 5 remains in the blocked state, it is possible to reduce light leakage at the time liquid crystal devices 8a, 8b are turned off.

If the orientation films are vertical orientation films, then as liquid crystal molecules in the vicinity of the vertical orientation films remain perpendicularly oriented even when a voltage is applied, light leakage in the lateral directions can further be reduced.

In the present exemplary embodiment, the orientation films on substrates 6, which are disposed adjacent to each other, of the stacked liquid crystal devices are oriented in mutually perpendicular directions. Such an arrangement is effective to increase contrast between the transmitted state and the blocked state.

In the present exemplary embodiment, the products of the thicknesses of liquid crystal materials 7 of liquid crystal devices 8a, 8b and the refractive index anisotropies of the liquid crystal materials should desirably be equal or substantially equal to each other. With this arrangement, since the polarization plane of the incident light is rotated to substantially equal degrees (in opposite directions) in respective liquid crystal devices 8a, 8b, it is possible to further reduce light leakage in the blocked state.

In the present exemplary embodiment, the chiral pitches of liquid crystal materials 7 of liquid crystal devices 8a, 8b should desirably be equal or substantially equal to each other. With this arrangement, since the polarization plane of the incident light is rotated at substantially equal rates in respective liquid crystal devices 8a, 8b, it is possible to further reduce like leakage in the blocked state.

In the present exemplary embodiment, the orientation film on one of the substrates of each of liquid crystal devices 8a, 8b is oriented in a widthwise direction of liquid crystal glasses 100. This arrangement makes it possible to reduce light leakage in lateral directions with respect to the observer.

In the present exemplary embodiment, the orientation films of liquid crystal devices 8a, 8b are horizontal orientation films. The longer axes of liquid crystal molecules on substrates 6 which have orientation films that are oriented in a widthwise direction of liquid crystal shutter glasses 100 are progressively spaced away from substrates 6 toward the inner side of liquid crystal shutter glasses 100. This arrangement makes it possible to reduce light leakage from the center of the face toward which the eyes tend to move when viewing displays.

### EXAMPLE 1

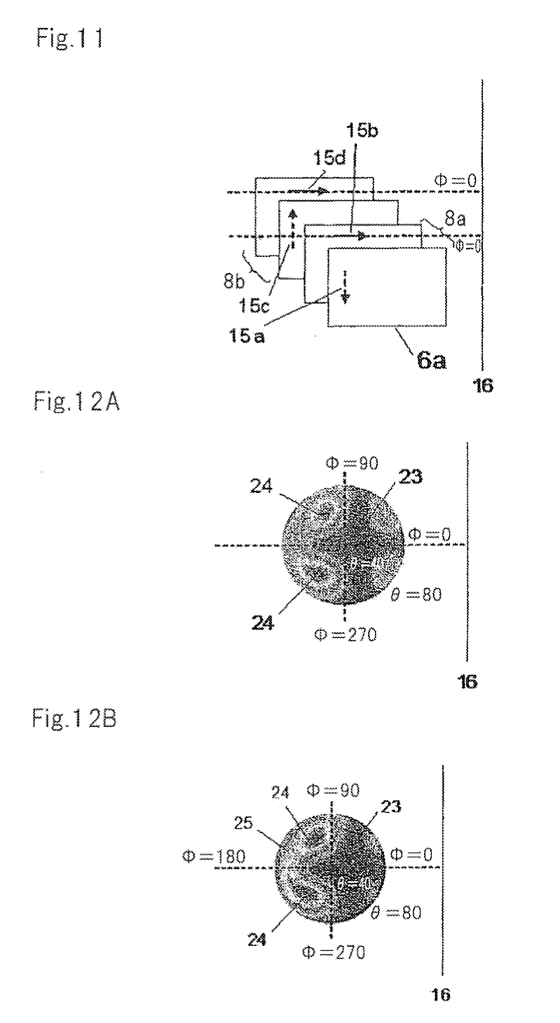

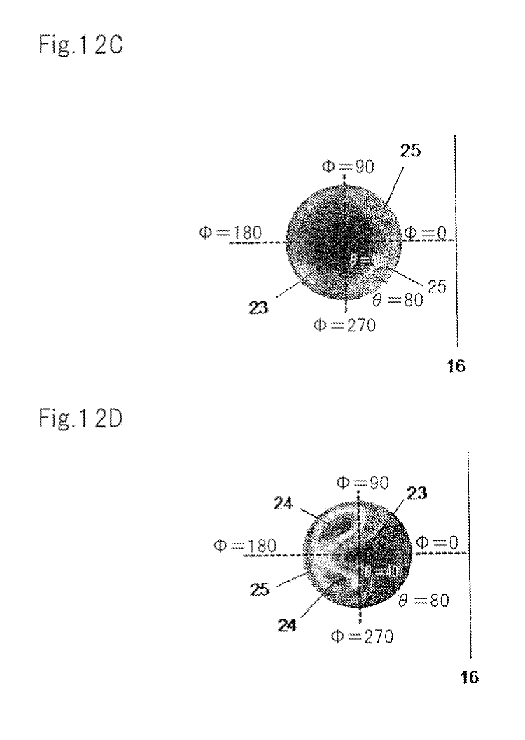

A luminance distribution of liquid crystal shutter glasses 100 which employ horizontal orientation films 11 according to Example 1 of the present invention will be described below with reference to FIGS. 11 and 12A through 12D.

Two liquid crystal devices 8a, 8b are employed. Liquid crystal devices 8a, 8b are 90° TN liquid crystal devices wherein a liquid crystal layer has thickness d of 2.3 μm and positive dielectric anisotropy Δn (0.17).

In liquid crystal shutter 5, as shown in FIG. 11, oriented directions 15b, 15d of the orientation films, which are oriented in the same direction, of liquid crystal devices 8a, 8b extend perpendicularly to central line 16 of the face of the observer, and the pretilt angles in oriented directions 15b, 15d are directed toward the center of the face of observer 2.

Respective liquid crystal materials 7 of liquid crystal devices 8a, 8b have chiral pitches depending on the twisted directions, and have a positive dielectric anisotropy Δn of positive 0.17.

FIG. 12A is a diagram showing a luminance distribution at the time a voltage (5V) is applied to liquid crystal devices 8a, 8b of liquid crystal shutter 5 shown in FIG. 11. Both liquid crystal devices 8a, 8b are in the ON state, bringing liquid crystal shutter 5 into the blocked state. In FIG. 12A, φ represents an azimuthal angle, and θ a polar angle. A line represented by φ=0−180° is aligned with lateral directions with respect to the observer.

Blocked region 23 (a region of low luminance) spreads in the vicinity of the like represented by φ=0−180°, and light leakage region 24 (a region of high luminance) spreads in the vicinity of angle φ=0−120°, angle θ=40 through 60° or angle φ=0−210°, angle θ=40 through 60°. Liquid crystal shutter 5 constructed as shown in FIG. 11 is capable of reducing light leakage in lateral directions with respect to the observer in the blocked state.

FIGS. 12B through 12D are diagrams illustrative of luminance distributions at the time liquid crystal devices 8a, 8b are turned off (when both liquid crystal devices in the ON state (5V applied) change to both liquid crystal devices in the OFF state (no voltage applied)). FIG.

12B shows a luminance distribution under conditions corresponding to an applied voltage of 4V, FIG. 12C a luminance distribution under conditions corresponding to an applied voltage of 3V, and FIG. 12D a luminance distribution under conditions corresponding to an applied voltage of 2 V.

In FIG. 12B, as with the ON state, light leakage region 24 spreads in the vicinity of angle φ=0−120°, angle θ=40 through 60° or angle φ=0−210°, angle θ=40 through 60°. In FIG. 12C, light leakage region 24 is reduced in its entirety. In FIG. 12D, light leakage region 24 spreads again in the vicinity of angle φ=0−120°, angle θ=40 through 60° or angle φ=0−210°, angle θ=40 through 60°.

In either case, it will be understood that since light leakage region 24 is not present in directions to the center of the face toward which the eyes of the observer tend to move, light leakage is reduced in lateral directions.

### EXAMPLE 2

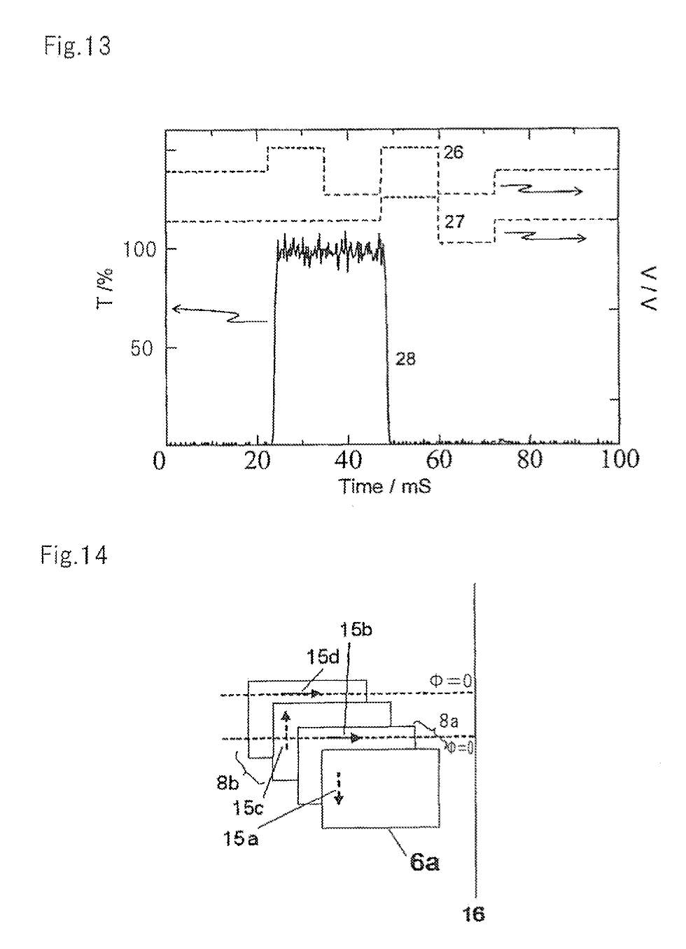

The response time of liquid crystal devices 8a, 8b incorporated in the liquid crystal shutter glasses according to Example 1 and light leakage when liquid crystal devices 8a, 8b are turned off according to Example 2 will be described below with reference to FIG. 13.

Liquid crystal devices 8a, 8b had a response time of 0.6 mS which is required to change from the blocked state to the transmitted state (the time required to achieve a change from a transmittance of 10% to a transmittance of 90%). Liquid crystal devices 8a, 8b also had a response time of 0.6 mS which is required to change from the transmitted state to the blocked state (a time required to achieve a change from a transmittance of 90% to a transmittance of 10%), as with the response time required to change from the blocked state to the transmitted state.

FIG. 13 is a diagram illustrative of light leakage in a frontal direction of liquid crystal shutter 5. In FIG. 13, the horizontal axis represents time [mS] and the vertical axis light transmittance [%]. In FIG. 13, voltage 26 represents a voltage applied to the first liquid crystal device, voltage 27 a voltage applied to the second liquid crystal device, and electrooptical response 28 an electrooptical response (transmittance) of liquid crystal shutter 5.

As shown in FIG. 13, even when liquid crystal shutter 5 is in the blocked state, i.e., when both the liquid crystal devices are in the ON state and both the liquid crystal devices are in the OFF state, and even when liquid crystal shutter 5 is turned off, i.e., when both the liquid crystal devices in the ON state change both of the liquid crystal devices in the OFF state, the light transmittance is about 0%, with no essential difference between the light transmittances in those states. Therefore, it can be seen that when liquid crystal shutter 5 is in the blocked state and when it is turned off, liquid crystal shutter 5 provides an electrooptical response free of light leakage in the frontal direction thereof.

### EXAMPLE 3

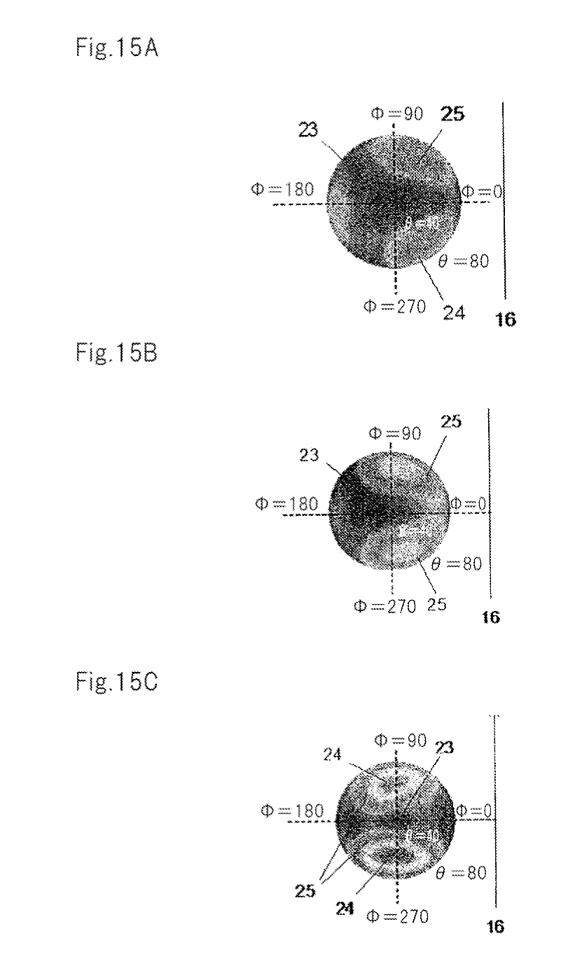

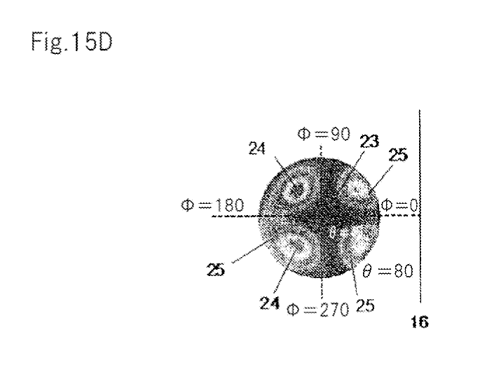

The luminance distribution of liquid crystal shutter glasses 100 which employ vertical orientation films according to Example 3 of the present invention will be described below with reference to FIGS. 14 and 15A through 15D.

Two liquid crystal devices 8a, 8b are employed. Liquid crystal devices 8a, 8b are R-TN liquid crystal devices wherein a liquid crystal layer has thickness d of 2.3 μm and dielectric anisotropy Δn of −0.17.

In liquid crystal shutter 5, as shown in FIG. 14, oriented directions 15b, 15d of the orientation films, which are oriented in the same direction, of liquid crystal devices 8a, 8b extend perpendicularly to central line 16 of the face of the observer, and the pretilt angles in oriented directions 15b, 15d are directed toward the center of the face of observer 2. As with FIGS. 12A through 12D, φ represents an azimuthal angle, and θ a polar angle. A line represented by φ=0−180° is aligned with lateral directions with respect to the observer.

FIG. 15A is a diagram showing the luminance distribution at the time a voltage (5V) is applied to liquid crystal devices 8a, 8b of liquid crystal shutter 5 shown in FIG. 13. Both liquid crystal devices 8a, 8b are in the ON state, bringing liquid crystal shutter 5 into the blocked state.

FIGS. 15B through 15D are diagrams illustrative of luminance distributions at the time liquid crystal devices 8a, 8b are turned off (when both liquid crystal devices in the ON state (5V applied) change to both liquid crystal devices in the OFF state (no voltage applied)). FIG. 15B shows a luminance distribution under conditions corresponding to an applied voltage of 4V, FIG. 15C a luminance distribution under conditions corresponding to an applied voltage of 3V, and FIG. 15D a luminance distribution under conditions corresponding to an applied voltage of 2 V.

As shown in FIGS. 15A through 15D, it was possible to achieve viewing angle characteristics having wider blocked regions in lateral directions with respect to the observer than with the assembly made up of two stacked TN, liquid crystal devices (FIGS. 12A through 12D), except under conditions corresponding to an applied voltage of 3 V (FIG. 15C).

### INDUSTRIAL APPLICABILITY

Applications of the present invention include display systems employing liquid crystal shutter glasses, such as stereoscopic display systems, multi-view display systems, etc. which utilize time-division displays.

While the present invention has been described above with respect to the exemplary embodiments, the present invention is not limited to the above exemplary embodiments. Various changes that can be understood by those skilled in the art can be made to the configuration and details of the present invention within the scope of the present invention.

This application is based upon and claims the benefit of priority from Japanese Patent Application No. 2009-44045 filed on Feb. 26, 2009, the entire disclosure of which is incorporated herein by reference.

1. A liquid crystal shutter comprising a stacked structural body of a stack of liquid crystal devices each including a pair of substrates coated with respective orientation films and a liquid crystal material sealed between the substrates, a polarizer disposed on one of two opposite sides of said stacked structural body, and an analyzer disposed on the other of the two opposite sides of said stacked structural body, wherein
the orientation films as a pair in said liquid crystal devices are oriented in directions which cross each other;
said orientation films comprise either horizontal orientation films or vertical orientation films, said liquid crystal material having a positive dielectric anisotropy if said orientation films comprise said horizontal orientation films, and said liquid crystal material having a negative dielectric anisotropy if said orientation films comprise said vertical orientation films; and
the liquid crystal materials of the liquid crystal devices which are disposed adjacent to each other in said stacked structural body are twisted in mutually opposite directions.

2. The liquid crystal shutter according to claim 1, wherein the orientation films on the substrates, which are disposed adjacent to each other, of the liquid crystal devices are oriented in mutually perpendicular directions.

3. The liquid crystal shutter according to claim 1, wherein the products of the thicknesses of the liquid crystal materials of the respective liquid crystal devices and the refractive index anisotropies of the liquid crystal materials are equal or substantially equal to each other.

4. The liquid crystal shutter according to claim 1, wherein the chiral pitches of the liquid crystal materials of the respective liquid crystal devices are equal or substantially equal to each other.

5. The Liquid crystal shutter glasses incorporating a liquid crystal shutter according to claim 1.

6. The liquid crystal shutter glasses according to claim 5, wherein said liquid crystal devices comprise two liquid crystal devices; and
in each of said liquid crystal devices, the orientation film on one of the substrates is oriented in a widthwise direction of the liquid crystal shutter glasses.

7. The liquid crystal shutter glasses according to claim 6, wherein the orientation films comprise said horizontal orientation films; and
the longer axes of liquid crystal molecules on the substrate which has the orientation film oriented in said widthwise direction are progressively spaced away from the substrate toward the inner side of the liquid crystal shutter glasses.
